(19) United States
(12) Patent Application Publication
(10) Pub. No.: US 2026/0056037 A1
(43) Pub. Date: Feb. 26, 2026

(54) Distributed Optical Fiber Sensing Event Recognition Method And Device Based On Optical Computing

(71) Applicant: Nanjing University, Nanjing (CN)

(72) Inventors: Ningmu Zou, Nanjing (CN); Mingwei Feng, Nanjing (CN); Kangjian Di, Nanjing (CN); Yixin Zhang, Nanjing (CN); Xuping Zhang, Nanjing (CN); Fuhao Yu, Nanjing (CN); Wei Jiang, Nanjing (CN)

(21) Appl. No.: 18/923,594

(22) Filed: Oct. 22, 2024

(30) Foreign Application Priority Data
Aug. 21, 2024 (CN) 2024111473271

(51) Int. Cl. G01D 5/353; H04B 10/071

(52) U.S. Cl. CPC G01D 5/35361; H04B 10/071

(57) ABSTRACT

The invention relates to a distributed optical fiber sensing event recognition method and device based on optical computing, and relates to the technical field of optical fiber sensing event identification. The invention collects two-dimensional time-frequency signals of distributed sensing information through a coherent detection type φ-OTDR system, and uses optical computing on the optical path to achieve accurate identification of sensing events. Optical computing includes optical convolution operations and optical full connection operations. The two-dimensional time-frequency signals are processed into one-dimensional tensors. Through the cooperation of an intensity amplitude modulator and a programmable multi-wavelength laser array, the neural network weights are loaded onto the light, thereby completing the optical neural network computing, and finally obtaining the corresponding light intensities of four wavelengths, thereby achieving accurate identification of sensing events.

### 1. TECHNICAL FIELD

The invention relates to the technical field of optical fiber sensing event recognition, and in particular to a distributed optical fiber sensing event recognition method and device based on optical computing.

### 2. BACKGROUND ART

With the accelerated development of industrialization and urbanization, higher requirements are put forward for environmental safety, public safety and infrastructure health monitoring. Distributed fiber optic sensors, with their high sensitivity, strong anti-electromagnetic interference ability and suitability for harsh environments, have shown unique advantages in structural health monitoring, temperature sensing, pressure measurement and boundary intrusion detection. Especially in long-distance, large-scale or high-requirement electromagnetic compatibility application scenarios, their unique performance is irreplaceable. This type of system uses the principles of Rayleigh scattering and Brillouin scattering of optical fibers to monitor changes in physical parameters such as temperature, strain or vibration along the optical fiber path. Its highly sensitive sensing characteristics, coupled with good adaptability to harsh environmental conditions (such as high electromagnetic interference and corrosive environments), make distributed fiber optic sensors widely used in key areas such as oil and gas pipeline monitoring, geological disaster warning, and building health monitoring.

However, although traditional distributed fiber optic sensing systems can provide continuous monitoring information, their data processing capabilities are limited by the photoelectric conversion efficiency and electronic signal processing speed. In the complex signal analysis and event identification process, this bottleneck may lead to response delays and fail to meet the needs of real-time monitoring and rapid response.

The emergence of optical computing technology provides a possible solution to this challenge. Optical computing uses photons instead of electrons to perform computing operations. Its processing speed is much faster than electronic computing, and it can directly process optical signals without converting them into electrical signals. This technology can greatly improve data processing speed, reduce energy consumption, and reduce signal loss during the conversion process. More importantly, optical computing can perform parallel processing on the signal path, allowing simultaneous identification and positioning of multiple events, improving the system's multi-tasking capabilities. Distributed fiber optic sensing systems based on optical computing combine the high sensitivity of fiber optic sensors with the high-speed data processing capabilities of optical computing, enabling rapid acquisition, processing and identification of optical signals, and providing real-time and efficient monitoring results. This emerging technology is expected to overcome the limitations of traditional systems and bring revolutionary progress to real-time security monitoring and accurate event positioning. Therefore, researching and developing event recognition methods based on optical computing is an inevitable trend in the development of distributed fiber optic sensing technology. In addition, since traditional fiber optic sensing technology relies on photoelectric converters and electrical signal processing equipment, the transmission and processing of electrical signals will inevitably introduce noise, reduce system stability, and increase system energy consumption. In order to overcome these shortcomings and improve the monitoring performance and adaptability of fiber optic sensing systems, a new event recognition technology is urgently needed.

### 3. SUMMARY OF THE INVENTION

The purpose of the invention is to provide a distributed optical fiber sensing event recognition method and device based on optical computing, aiming to provide an efficient, reliable and highly applicable optical fiber sensing event identification method that can achieve high-sensitivity monitoring and has high-speed signal processing capabilities to adapt to complex and changeable monitoring environments and respond to various emergencies, thereby ensuring the safety of people's lives and property and the stability of social operations.

In order to achieve the above purpose, the invention provides the following solutions:
a distributed optical fiber sensing event recognition method based on optical computing, including a distributed sensing information processing part, an optical convolution computing part, and an optical full connection computing part;
wherein the distributed sensing information processing part includes:
(1) obtaining phase information along the length of the optical fiber through the optical fiber sensing system (such as φ-OTDR) and demodulating it into a two-dimensional time-frequency signal; mapping the amplitude of the phase change to the brightness of the grayscale image, wherein the grayscale level represents the phase change; outputting the image signal of the C channel, and dividing the image signal containing the sensing information into multiple C-channel H×W images;
(2) adopting an improved YOLOv8 micro-detection framework with an attention mechanism (Swin-Transformer) and an efficient detection head (Shape-IoU) to locate and crop sensitive areas containing sensing events in image signals; the input image size of the model is [C₁, H₁, W₁], and the output image size is [n, C₂, H₂, W₂], wherein n is the number of cropped events;
(3) converting the image of size [C₂, H₂, W₂] into a single-channel grayscale image, and reducing the size of each grayscale image to 36×36 by bilinear interpolation;
the optical convolution computing part includes:
(1) according to the convolution kernel size and step size requirements, expanding the 36×36 two-dimensional image signal into a one-dimensional tensor;
(2) sending the one-dimensional tensor with 8 effective bits to the microprocessor, and the raw data is converted into a corresponding voltage waveform through an arbitrary waveform generator, which drives the light intensity amplitude modulator;
(3) sending the value of the convolution kernel and the corresponding weight to the microprocessor, which modulates the programmable multi-wavelength laser array by generating corresponding electrical signals;
(4) multiplexing light of different wavelengths into a single optical fiber and outputting it to a light intensity amplitude modulator; the optical signals loaded with the convolution kernel factor enter the modulator and is modulated;
(5) selecting the optical convolution channel for the optical switch, and outputting the multiplied optical signals to the single-mode optical fiber; the single-mode optical fiber causes a one-bit time delay between the time domain waveforms of each wavelength; detecting the intensity of light in different time domains by a second photodetector, thereby completing the addition of the optical convolution;
(6) a multi-channel parallel data acquisition card collects the signal after optical convolution and outputs it to a computer to restore it into a feature graph;
the optical full connection computing part includes:
(1) sending the activated one-dimensional tensor to the microprocessor, and the microprocessor generates a corresponding time domain waveform to control the light intensity amplitude modulator;
(2) sending the fully connected weights to the microprocessor, and the microprocessor generates a corresponding electrical signal to modulate the programmable multi-wavelength laser array; controlling the microprocessor to synchronously send the flattened one-dimensional tensor to the arbitrary waveform generator, and the arbitrary waveform generator generates a corresponding time domain waveform to the light intensity amplitude modulator;
(3) multiplexing light of different wavelengths into a single optical fiber and output it to a light intensity amplitude modulator; the light intensity amplitude modulator modulates the multiplexed light and loads the one-dimensional tensor signal onto different wavelengths to achieve optical full connection weight loading;
(4) selecting the optical full connection channel for the optical switch, and outputting the weighted optical signals to a wavelength demultiplexer, which separates multiple wavelengths of light, detects the intensity of light of different wavelengths, and converts into electrical signals and outputs to the computer; by time accumulation, the intensity of different wavelengths of light is obtained;
(5) according to the intensity of different light wavelengths, classifying the sensing events into: background, knocking, walking, and fence; the wavelength of the programmable multi-wavelength laser array is 4 bands; in the full connection terminal, the photoelectric detector receives the light intensity at different times; light of different wavelengths is accumulated in the time domain and classified to obtain the corresponding four light intensities; the four light intensities are normalized and uniformly mapped to the range of 0% to 100%; the higher the light intensity, the higher the probability of the corresponding sensing event, and the band with the highest light intensity corresponds to the predicted result.

A distributed optical fiber sensing event recognition device based on optical computing, wherein the device can implement the distributed optical fiber sensing event recognition method based on optical computing; the device specifically comprises: a narrow linewidth laser, a first optical coupler, an acousto-optic modulator, an erbium-doped fiber amplifier, a circulator, a sensing fiber, a second optical coupler, a first photodetector, an acousto-optic modulation driver, a data acquisition card, a computer, a programmable multi-wavelength laser array, a wavelength multiplexer, an arbitrary waveform generator, an intensity amplitude modulator, an optical switch, a first semiconductor optical amplifier, a wavelength demultiplexer, a photodetector array, a second semiconductor optical amplifier, a second photodetector, a multi-channel parallel data acquisition card, and a microprocessor;
the narrow linewidth laser is used to emit narrow linewidth and high-correlation continuous laser;
the first optical coupler is used to split the continuous laser light input by the narrow linewidth laser into two paths, one path is a detection light signal, and the other path is a reference light signal;
the acousto-optic modulator is modulated by the acousto-optic modulation driver to modulate the continuous laser input by the first optical coupler into a pulse probe laser;
the erbium-doped fiber amplifier is used to amplify the pulse probe laser input by the acousto-optic modulator;
the loop is used to input the pulse probe laser amplified by the erbium-doped fiber amplifier into the sensing fiber, and receive the back Rayleigh scattered light reflected by the sensing fiber;
the second optical coupler is used to couple the reference optical signal input by the first optical coupler and the back Rayleigh scattered light input by the loop;
the first photodetector is used to detect the coupled light input by the second optical coupler and convert the coupled light into interference electrical signals;
the data acquisition card is used to collect the interference electrical signal of the first photodetector, and convert the interference electrical signals into digital signals, and output it to a computer; the data acquisition card is also used to output a clock carrier signal and a pulse trigger modulation signal to the acousto-optic modulation driver, so that the acousto-optic modulator outputs a high-level pulse modulation signal to the acousto-optic modulator;
the computer is used to control the working state of the data acquisition card and analyze and process the digital signals collected by the data acquisition card;
the microprocessor is controlled by the computer and is used to send clock signals and weights to the programmable multi-wavelength laser array;
the programmable multi-wavelength laser array is used to output lasers with different wavelength weights;
the wavelength multiplexer is used to multiplex a plurality of lasers of different wavelengths into a single optical fiber and output them to the light intensity amplitude modulator;
the arbitrary waveform generator is controlled by the microprocessor and is used to convert the time domain waveform signals generated by the microprocessor into a high-speed waveform;
the light intensity amplitude modulator is used to load the high-speed waveform generated by the arbitrary waveform generator onto each wavelength in a single optical fiber, complete the loading of the time domain signal, and output to the optical switch;
the optical switch switches the optical convolution computing and the optical full connection computing according to the clock signals sent by the microprocessor, and outputs to the first semiconductor optical amplifier or the single-mode optical fiber under different electrical signals;
the single-mode optical fiber is used to generate a time delay of one bit between the time domain waveforms of each wavelength, and output it to the second semiconductor amplifier;
the second semiconductor amplifier is used to amplify the optical signal that needs to be subjected to optical convolution computing;
the second photodetector is used to detect the time domain intensity of the optical signal amplified by the second semiconductor amplifier, and output the total power of all wavelengths of light in each time interval, and convert the total power of all wavelengths of light in each time interval into an electrical signal;
the first semiconductor optical amplifier is used to amplify the optical signal that needs to be subjected to optical full connection computing;
the wavelength demultiplexer is used to demultiplex the optical signal that needs to be subjected to optical full connection computing, separate a plurality of lights of different wavelengths, and convert the plurality of lights of different wavelengths into electrical signals;
the photodetector array is used to detect the intensity of the multiple lights of different wavelengths and convert the intensity of the multiple lights of different wavelengths into electrical signals;
in optical convolution computing, the multi-channel parallel data acquisition card is used to receive the electrical signals of the second photodetector;
in optical full connection computing, the multi-channel parallel data acquisition card is used to receive the electrical signals of the photodetector array and output to the computer;
the computer is also used to receive the electrical signals collected by the multi-channel parallel data acquisition card, convert the electrical signals into two-dimensional time-frequency signals, convert the two-dimensional time-frequency signals into one-dimensional tensors, and restore the one-dimensional signals after optical convolution computing into two-dimensional time-frequency signals, output the judgment results of distributed optical fiber sensing events: background, knocking, walking, and fence, and output the clock signals, weights, and one-dimensional tensors to the microprocessor;
the microprocessor is also used to convert the one-dimensional tensor into a time domain waveform signal and output to the arbitrary waveform generator.

According to specific embodiments provided by the invention, the invention discloses the following technical effects: by collecting two-dimensional time-frequency signals of distributed sensing information, and using optical computing on the optical path, accurate identification of sensing events is achieved. Processing sensing signals through optical computing avoids dependence on electronic computing resources, improves the response speed and anti-interference ability of the sensing system, and has significant performance advantages when processing large-scale sensing data; through distributed processing, it enhances the fault tolerance and reliability of the system; at the same time, it introduces tensor acceleration technology to further improve the calculation speed of distributed sensing signals, and has the advantages of high recognition accuracy and large data throughput.

### 4. BRIEF DESCRIPTION OF THE DRAWINGS

In order to explain the embodiments of the invention or the technical solutions in the prior art more clearly, the drawings that need to be used in the description of the embodiments or the prior art will be introduced hereinafter. Obviously, the drawings in the following description are only some embodiments of the invention. For those of ordinary skill in the art, other drawings may be obtained from these drawings without creative efforts.

FIG. 1 is a system structure diagram provided according to the invention.

FIG. 2 is a diagram showing the classification events involved according to the invention.

FIG. 3 is a schematic diagram of converting a two-dimensional signal of a distributed optical fiber sensing event into a one-dimensional tensor according to the invention.

FIG. 4 is a schematic diagram of optical full connection computing according to the invention.

FIG. 5 is a schematic diagram of a specific Dropout implementation provided according to the invention.

### 5. SPECIFIC EMBODIMENT OF THE INVENTION

The technical solutions in the embodiments of the invention will be clearly and completely described hereinafter with reference to the drawings in the embodiments of the invention. Obviously, the described embodiments are only a part of the embodiments of the invention, rather than all the embodiments. Based on the embodiments of the invention, all other embodiments obtained by those of ordinary skill in the art without creative efforts shall fall within the protection scope of the invention.

The purpose of the invention is to provide a distributed optical fiber sensing event recognition method and device based on optical computing, which can perform optical computing on the optical path to achieve accurate recognition of distributed optical fiber sensing events.

In order to make the above purposes, features and advantages of the invention more obvious and easy to understand, the invention is further described in detail hereinafter with reference to the drawings and specific embodiments.

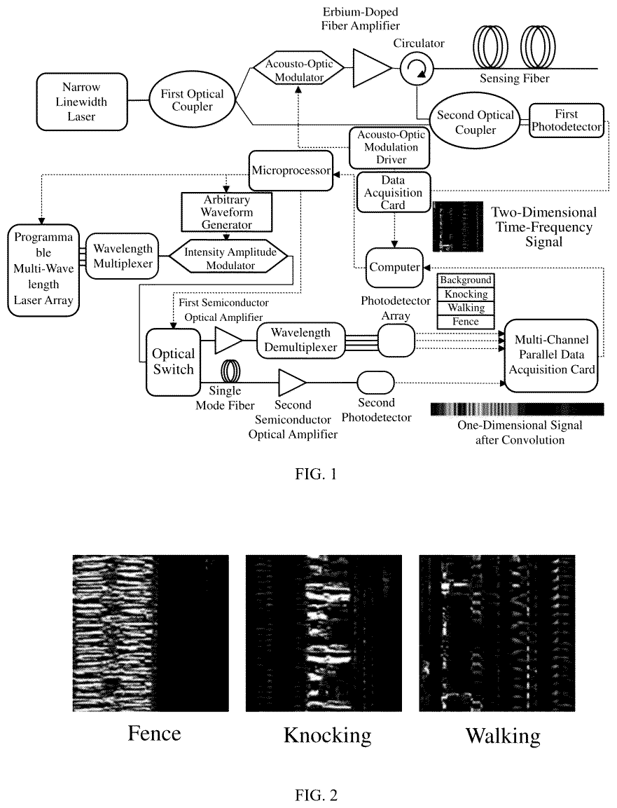

FIG. 1 is a system structure diagram of the distributed optical fiber sensing event recognition device based on optical computing provided according to the invention. The system of the device is divided into a coherent detection type q-OTDR subsystem and an optical computing subsystem; the coherent detection type-OTDR subsystem specifically comprises: a narrow linewidth laser, a first optical coupler, an acousto-optic modulator, an erbium-doped fiber amplifier, a circulator, a sensing fiber, a second optical coupler, a first photodetector, an acousto-optic modulation driver, a data acquisition card, and a computer; the optical computing subsystem specifically comprises: a programmable multi-wavelength laser array, a wavelength multiplexer, an arbitrary waveform generator, an intensity amplitude modulator, an optical switch, a first semiconductor optical amplifier, a wavelength demultiplexer, a photodetector array, a second semiconductor optical amplifier, a second photodetector, a multi-channel parallel data acquisition card, a microprocessor, and a computer.
the narrow linewidth laser is used to emit narrow linewidth and high-correlation continuous laser;
the first optical coupler is used to split the continuous laser light input by the narrow linewidth laser into two paths, one path is a detection light signal, and the other path is a reference light signal;
the acousto-optic modulator is modulated by the acousto-optic modulation driver to modulate the continuous laser input by the first optical coupler into a pulse probe laser;
the erbium-doped fiber amplifier is used to amplify the pulse probe laser input by the acousto-optic modulator;
the loop is used to input the pulse probe laser amplified by the erbium-doped fiber amplifier into the sensing fiber, and receive the back Rayleigh scattered light reflected by the sensing fiber;
the second optical coupler is used to couple the reference optical signal input by the first optical coupler and the back Rayleigh scattered light input by the loop;
the first photodetector is used to detect the coupled light input by the second optical coupler and convert the coupled light into interference electrical signals;
the data acquisition card is used to collect the interference electrical signal of the first photodetector, and convert the interference electrical signals into digital signals, and output it to a computer; the data acquisition card is also used to output a clock carrier signal and a pulse trigger modulation signal to the acousto-optic modulation driver, so that the acousto-optic modulator outputs a high-level pulse modulation signal to the acousto-optic modulator;
the computer is used to control the working state of the data acquisition card and analyze and process the digital signals collected by the data acquisition card;
the microprocessor is controlled by the computer and is used to send clock signals and weights to the programmable multi-wavelength laser array;
the programmable multi-wavelength laser array is used to output lasers with different wavelength weights;
the wavelength multiplexer is used to multiplex a plurality of lasers of different wavelengths into a single optical fiber and output them to the light intensity amplitude modulator;
the arbitrary waveform generator is controlled by the microprocessor and is used to convert the time domain waveform signals generated by the microprocessor into a high-speed waveform;
the light intensity amplitude modulator is used to load the high-speed waveform generated by the arbitrary waveform generator onto each wavelength in a single optical fiber, complete the loading of the time domain signal, and output to the optical switch;
the optical switch switches the optical convolution computing and the optical full connection computing according to the clock signals sent by the microprocessor, and outputs to the first semiconductor optical amplifier or the single-mode optical fiber under different electrical signals;
the single-mode optical fiber is used to generate a time delay of one bit between the time domain waveforms of each wavelength, and output it to the second semiconductor amplifier;
the second semiconductor amplifier is used to amplify the optical signal that needs to be subjected to optical convolution computing;
the second photodetector is used to detect the time domain intensity of the optical signal amplified by the second semiconductor amplifier, and output the total power of all wavelengths of light in each time interval, and convert the total power of all wavelengths of light in each time interval into an electrical signal;
the first semiconductor optical amplifier is used to amplify the optical signal that needs to be subjected to optical full connection computing;
the wavelength demultiplexer is used to demultiplex the optical signal that needs to be subjected to optical full connection computing, separate a plurality of lights of different wavelengths, and convert the plurality of lights of different wavelengths into electrical signals;
the photodetector array is used to detect the intensity of the multiple lights of different wavelengths and convert the intensity of the multiple lights of different wavelengths into electrical signals;
in optical convolution computing, the multi-channel parallel data acquisition card is used to receive the electrical signals of the second photodetector;
in optical full connection computing, the multi-channel parallel data acquisition card is used to receive the electrical signals of the photodetector array and output to the computer;
the computer is also used to receive the electrical signals collected by the multi-channel parallel data acquisition card, convert the electrical signals into two-dimensional time-frequency signals, convert the two-dimensional time-frequency signals into one-dimensional tensors, and restore the one-dimensional signals after optical convolution computing into two-dimensional time-frequency signals, output the judgment results of distributed optical fiber sensing events: background, knocking, walking, and fence, and output the clock signals, weights, and one-dimensional tensors to the microprocessor;
the microprocessor is also used to convert the one-dimensional tensor into a time domain waveform signal and output to the arbitrary waveform generator.

Based on the above a distributed optical fiber sensing event recognition device based on optical computing, the corresponding recognition method includes the following steps.

step 1: the narrow-linewidth laser emits narrow-linewidth, high-correlation continuous light to the first optical coupler, and the optical signal is divided into two parts (the splitting ratio is 90:10); 90% of the light is used as sensing light and output to the acousto-optic modulator, and 10% of the light is used as reference light and output to the second optical coupler.

Step 2: the data acquisition card sends a signal to the acousto-optic modulation driver, which sends a high-level pulse modulation signal to control the acousto-optic modulator. The acousto-optic modulator modulates the sensing light, and the modulated light is power-amplified by the erbium-doped fiber amplifier and output to the loop; the sensing light is sensed and reflected to the second optical coupler (with a split ratio of 50:50) to couple with 10% of the reference light.

Step 3: the light coupled by the second optical coupler contains the sensing information, which is output to the first photodetector and converted into an electrical signal; after being processed by the data acquisition card, it is sent to the computer; the computer converts the sensing signal into a three-channel two-dimensional time-frequency signal; the event categories include background, knocking, walking, and fence; the two-dimensional time-frequency signals of some events are shown in FIG. 2.

Step 4: expanding the two-dimensional time-frequency signal into a one-dimensional tensor and inputting it into the microprocessor; the microprocessor controls the programmable multi-wavelength laser array to emit optical signals of different wavelengths; the optical signals are multiplexed into a single optical fiber through the wavelength multiplexer; the microprocessor sends an electrical signal to control the arbitrary waveform transmitter to generate a time domain waveform corresponding to the one-dimensional tensor to modulate the light intensity amplitude modulator.

Step 5: the microprocessor controls the optical switch to switch the optical convolution calculation channel; the optical signal after optical convolution is output to the second semiconductor optical amplifier through the single-mode optical fiber, and then output to the second photodetector to be converted into an electrical signal; the microprocessor controls the optical switch to switch the optical full-connection calculation channel; the optical signal after optical full-connection computing is output to the wavelength demultiplexer through the first semiconductor optical amplifier, and then output to the photodetector array to be converted into an electrical signal.

Step 6: the multi-channel parallel data acquisition card collects the electrical signals of the second photodetector and the photodetector array and outputs them to the computer, which processes the data.

In one embodiment, a distributed optical fiber sensing event recognition method based on optical computing, including a distributed sensing information processing part, an optical convolution computing part, and an optical full connection computing part;
wherein the distributed sensing information processing part includes:
(1) obtaining the sensing signal of the sensing event and demodulating into a two-dimensional time-frequency signal; the grayscale value of each pixel in the grayscale image corresponds to the phase change measured by the optical fiber sensor at a specific position. The area with a large phase change can be marked by a higher or lower grayscale value, thereby forming a clear contrast in the image; then outing a 3-channel image signal and cropping the image signal containing the sensing information into multiple 3-channel 128×128 images.
(2) adopting the YOLOv8 neural network loaded with pre-trained weights improved backbone and detection head to locate and crop the areas containing sensing events in the image signals; the backbone part adopts the Swin-Transformer module to replace the original traditional convolution and other operations to achieve feature extraction; at the same time, the window attention mechanism has an efficiency advantage over the traditional ViT; the detection head part introduces shape-IoU as a regression loss function; by considering the influence of the shape and angle of the bounding box itself on the detection accuracy, the model input image size is [3, 750, 750], and the output image size is [n, 3, 128, 128], wherein n is the number of cropped events.
(3) converting the 3-channel 128×128 image into a single-channel grayscale image and reduce the size of each grayscale image to 36×36 by bilinear interpolation.
specifically, in the process of distributed fiber optic sensing signal positioning and cropping, the backbone part uses the Swin-Transformer module to replace the original traditional convolution and other operations to achieve feature extraction; at the same time, the window attention mechanism has an efficiency advantage over the traditional ViT. It first splits the input [H, W, 3] 3-channel 750×750 image into several equal-sized (P×P) but non-overlapping [N0, P, P, 3] sub-images (Ni represents the number of sub-images in the i-th stage, the number of original sub-images

$$N 0 = \frac{H}{P} \times \frac{W}{P} )$$

through the splitting module and flattens it into a sequence of [N0, (P2×3)] as a token sequence. Then, in the first stage, projecting this token sequence tensor into a new token tensor of shape [N0, C] through a linear layer and enters the Swin-Transformer module for two feature extractions while keeping the output shape unchanged

$$( N 1 = \frac{H}{P} \times \frac{W}{P} ) ,$$

thereby completing the first-level feature keeping the output shape unchanged extraction. In the second stage, the merging layer is used to splice adjacent 2×2 sub-images into new sub-images as the second-level features, and the token tensor changes to [N2, 2C]

$$( N 2 = \frac{H}{2 P} \times \frac{W}{2 P} ) .$$

Similar to the second stage, after the sub-images are re-spliced, the third and fourth stages perform 6 and 2 Swin-Transformer module feature extractions respectively to complete the third and fourth-level feature extractions, and the token tensor changes to [N3, 4C]

$$( N 2 = \frac{H}{4 P} \times \frac{W}{4 P} )$$

and [N4, 8C]

$$( N 4 = \frac{H}{8 P} \times \frac{W}{8 P} ) .$$

Through these four stages, the hierarchical extraction of image features is completed while ensuring a certain computational efficiency.

In order to make the bounding box regression more accurate and fully include the scope of the entire event, a bounding box regression method focusing on the shape and scale of the bounding box itself is used during cropping. First, the GT bounding box regression characteristics are analyzed, and it is concluded that the bounding box's own shape factors and scale factors will affect the regression results. Among them, the Shape-IoU method can calculate the loss by focusing on the bounding box's own shape and scale, thereby making the predicted bounding box regression more accurate and better locating the fiber optic sensing event. Then performing cropping with this half as the center. After introducing the Anchor-Free Center-based methods (based on the center point), the model changes from outputting “anchor box size offset” to “predicting the distance between the left, top, right, and bottom bounding boxes of the target box and the target center point (ltrb=left, top, right, bottom)”. In order to cooperate with Anchor-Free and improve generalization, DFL loss is added in v8. DFL optimizes the probability of the two positions closest to the label y in the form of cross entropy, so that the network can focus on the target position and the distribution of the neighboring area more quickly. The image size of the model input is [C1, H1, W1], and the output image size is [n, C2, H2, W2], wherein n is the number of events.

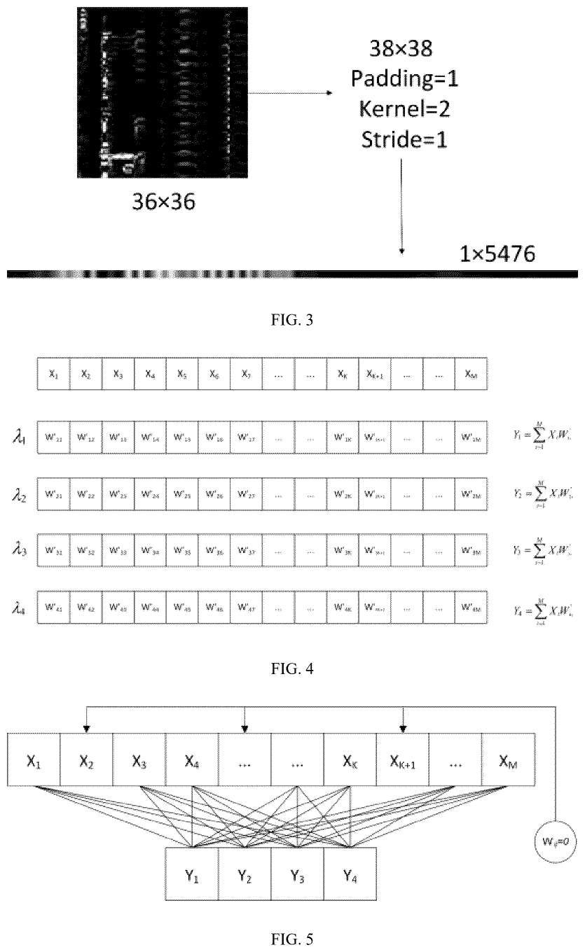

After completing the distributed sensing information processing, the optical convolution computing part can be started, and the specific steps are as follows:
(1) according to the convolution kernel size and step size requirements (the convolution kernel size is 2×2 and the step size is 1), the 36×36 two-dimensional image signal is expanded into a one-dimensional tensor for data preparation for subsequent one-dimensional convolution calculations; the size of the expanded one-dimensional tensor is 1×5476, as shown in FIG. 3. Specifically, traversing the input image, with the stride size as the step size, and extracting a local area at each position of the image; expanding each local area into a column vector and arranging them in columns of the output matrix; when expanding, it can be in row-first or column-first order; each column of the final output matrix corresponds to a local area in the input image, and the entire output matrix contains all possible local areas in the input image.
(2) the computer sends the expanded one-dimensional sensor signal and the expanded convolution kernel to the microprocessor. The microprocessor sends an electrical signal to control the arbitrary waveform generator to generate the corresponding time domain waveform. The microprocessor sends an electrical signal to control the programmable multi-wavelength laser array to generate four wavelengths of laser. The power of each wavelength corresponds to the convolution kernel, and then it is multiplexed into a single optical fiber through a wavelength multiplexer.
(3) sending the value of the convolution kernel and the corresponding weight to the microprocessor, which modulates the programmable multi-wavelength laser array by generating corresponding electrical signals.
(4) the arbitrary waveform generator generates the corresponding time domain waveform, and the light intensity amplitude modulator modulates the optical signal to complete the multiplication part of the optical convolution. The rate of the arbitrary waveform generator is 12.5 Gbps, the vertical resolution is 10 bits, the bandwidth is 5.3 GHZ, and the corresponding time to send one bit is 80 ps.
(5) the microprocessor sends an electrical signal to control the optical switch to switch the optical convolution channel. The switching speed of the optical switch is 10 ms. The multiplied optical signal is output to the single-mode optical fiber. The single-mode optical fiber causes a time delay of one bit between the time domain waveforms of each wavelength. The dispersion coefficient of the single-mode optical fiber is 20 ps/(nm·km). The distance of the single-mode optical fiber is 2 km, and the wavelength change is 2 nm, that is, the corresponding phase delay is 80 ps, corresponding to one bit of data. Then detecting the intensity of light in different time domains by the second photodetector. The bandwidth of the second photodetector is 40 GHz, thereby completing the addition of the optical convolution.
a multi-channel parallel data acquisition card collects the signal after optical convolution and outputs it to a computer. Redundant data will be generated when the misaligned vectorized data is performed accumulation calculation at the photoelectric detector. The effective information is extracted by the computer, and the final result is restored to a feature graph. Specifically, traversing the input column vectors and restoring each column vector to a local area in the original image according to the corresponding position; filling each local area back to the corresponding position of the original image; the final output is the restored original image, which is then activated by the Relu layer to increase the nonlinearity of the model.

After completing the optical convolution computing part, the optical full connection computing part can be started, and the specific steps are as follows:
(1) sending the activated one-dimensional tensor to the microprocessor, and the microprocessor generates a corresponding time domain waveform to control the light intensity amplitude modulator;
(2) sending the fully connected weights to the microprocessor, and the microprocessor generates a corresponding electrical signal to modulate the programmable multi-wavelength laser array; controlling the microprocessor to synchronously send the flattened one-dimensional tensor to the arbitrary waveform generator, and the arbitrary waveform generator generates a corresponding time domain waveform to the light intensity amplitude modulator; the rate of the arbitrary waveform generator is 12.5 Gbps; loading weights onto different wavelengths;
(3) multiplexing light of different wavelengths into a single optical fiber and outputting it to a light intensity amplitude modulator; the optical intensity amplitude modulator modulates the multiplexed light to load the one-dimensional tensor signal onto different wavelengths, thus realizing the weight loading of optical full connection;
(4) selecting the optical full connection channel for the optical switch, and outputting the weighted optical signals to a wavelength demultiplexer, which separates multiple wavelengths of light, and the bandwidth of each photodetector in the photodetector array is 40 GHZ, detects the intensity of light of different wavelengths, and converts into electrical signals and outputs to the computer; by time accumulation, the intensity of different wavelengths of light is obtained;
in the optical full connection computing part, combined with the Dropout operation, the events of distributed optical fiber sensing are: background, knocking, walking, and fence, corresponding to the outputs Y₁, Y₂, Y₃, and Y₄, as shown in FIG. 4; assuming that the output is each neuron, the output can be expressed by the following formula:

$${Y}_{i} = WX + b$$

wherein X is the input of the current layer, W is the pre-trained weight matrix, and b is the bias vector; when performing optical full connection computing:

$${Y}_{i} = {W}^{′} X$$

$${W}^{′} = \frac{WX + b}{X}$$

It can be obtained from the above formula that when implementing optical full connection computing on the optical path, it is only necessary to load weights on the programmable multi-wavelength laser array, corresponding to the customized intensity output of each wavelength on the programmable multi-wavelength laser array, and finally output different light intensities for each wavelength. The Dropout operation is introduced, as shown in FIG. 5. When the electrical signal modulates the arbitrary waveform generator, the input characteristic time domain waveform can be randomly modulated and set to zero to simulate the effect of the neuron output being set to zero during the Dropout process, thereby reducing overfitting.
(5) according to the intensity of different light wavelengths, classifying the sensing events into: background, knocking, walking, and fence; the wavelength of the programmable multi-wavelength laser array is 4 bands; the higher the light intensity, the higher the probability of the corresponding sensing event, and the band with the highest light intensity corresponds to the predicted result.

Specifically, in the optical full connection computing part, it involves converting electronic signals into optical signals and using optical signals for data processing and classification, which includes the following steps:
S1. converting the weight of the full connection layer into an electrical signal: the weight of the full connection layer needs to be sent to the microprocessor, and the microprocessor generates a corresponding electrical signal based on the received weight data;
S2. electrical signals modulate laser array: the microprocessor uses electrical signals to modulate the programmable multi-wavelength laser array; each laser emits a light signal of a specific wavelength; at the same time, the microprocessor sends the flattened one-dimensional tensor data to the arbitrary waveform generator, which generates the corresponding time domain waveform to the light intensity amplitude modulator for further modulating the light signal;
S3. multiplexing and modulating optical signals: using wavelength division multiplexing technology to combine optical signals of different wavelengths and transmitting to a single optical fiber; the optical signals are further modulated when passing through the light intensity amplitude modulator to load the one-dimensional tensor signal onto light of different wavelengths, that is, loading the corresponding full connection layer weights on each wavelength;
S4. demultiplexing wavelength and detecting signals: the optical signals after weight loading are transmitted to the wavelength demultiplexer through the optical fiber, and the demultiplexer separates the multiplexed optical signals into different wavelengths; the light intensity of each wavelength is converted into an electrical signal through the optical detector and output to the computer; the computer performs temporal accumulation processing on the light intensity of different wavelengths to obtain the total light intensity information of each wavelength;
S5. classifying and predicting: according to the light intensity of different wavelengths, the computer classifies the sensing events, including background, knocking, walking, and fence; according to the preset mode, the higher the light intensity band, the higher the probability of the corresponding event.

Specifically, in the optical full connection computing part, for discrete systems, the intensity and routing of multiple wavelengths are controlled through a programmable multi-wavelength laser array, and the update rate of the weight on the programmable multi-wavelength laser array is consistent with the modulator rate to ensure clock synchronization; for on-chip integrated systems, an light intensity amplitude modulator is used to load the full connection weights onto the time domain waveform of a one-dimensional tensor signal to complete the loading of the weights of each wavelength.

In the invention, processing sensing signals through optical computing avoids dependence on electronic computing resources, improves the response speed and anti-interference ability of the sensing system, and has significant performance advantages when processing large-scale sensing data; through distributed processing, it enhances the fault tolerance and reliability of the system; at the same time, it introduces tensor acceleration technology to further improve the calculation speed of distributed sensing signals, and has the advantages of high recognition accuracy and large data throughput.

The various embodiments in this specification are described in a progressive manner, and each embodiment focuses on the differences from other embodiments. The same or similar parts between the various embodiments can be referenced to each other.

This article uses specific embodiments to illustrate the principles and implementation methods of the invention. The above embodiments are only used to help understand the method and core ideas of the invention. At the same time, for those skilled in the art, according to the ideas of the invention, there will be modifications in the specific implementation methods and application scope. In summary, the content of this specification should not be understood as limiting the invention.

1. A distributed optical fiber sensing event recognition method based on optical computing, including a distributed sensing information processing part, an optical convolution computing part, and an optical full connection computing part;
wherein the distributed sensing information processing part includes:
(1) obtaining phase information along the length of the optical fiber through the optical fiber sensing system and demodulating it into a two-dimensional time-frequency signal; mapping the amplitude of the phase change to the brightness of the grayscale image, wherein the grayscale level represents the phase change; outputting the image signal of the C channel, and dividing the image signal containing the sensing information into multiple C-channel H×W images;
(2) adopting an improved YOLOv8 micro-detection framework with an attention mechanism and an efficient detection head to locate and crop sensitive areas containing sensing events in image signals; the input image size of the model is [C₁, H₁, W₁], and the output image size is [n, C₂, H₂, W₂], wherein n is the number of cropped events;
(3) converting the image of size [C₂, H₂, W₂] into a single-channel grayscale image, and reducing the size of each grayscale image to 36×36 by bilinear interpolation;
the optical convolution computing part includes:
(1) according to the convolution kernel size and step size requirements, expanding the 36×36 two-dimensional image signal into a one-dimensional tensor;
(2) sending the one-dimensional tensor to the microprocessor, and the raw data is converted into a corresponding voltage waveform through an arbitrary waveform generator, which drives the light intensity amplitude modulator;
(3) sending the value of the convolution kernel and the corresponding weight to the microprocessor, which modulates the programmable multi-wavelength laser array by generating corresponding electrical signals;
(4) multiplexing light of different wavelengths into a single optical fiber and outputting it to a light intensity amplitude modulator; the optical signals loaded with the convolution kernel factor enter the modulator and is modulated;
(5) selecting the optical convolution channel for the optical switch, and outputting the multiplied optical signals to the single-mode optical fiber; the single-mode optical fiber causes a one-bit time delay between the time domain waveforms of each wavelength; detecting the intensity of light in different time domains by a second photodetector, thereby completing the addition of the optical convolution;
(6) a multi-channel parallel data acquisition card collects the signal after optical convolution and outputs it to a computer to restore it into a feature graph;
the optical full connection computing part includes:
(1) sending the activated one-dimensional tensor to the microprocessor, and the microprocessor generates a corresponding time domain waveform to control the light intensity amplitude modulator;
(2) sending the fully connected weights to the microprocessor, and the microprocessor generates a corresponding electrical signal to modulate the programmable multi-wavelength laser array; controlling the microprocessor to synchronously send the flattened one-dimensional tensor to the arbitrary waveform generator, and the arbitrary waveform generator generates a corresponding time domain waveform to the light intensity amplitude modulator;
(3) multiplexing light of different wavelengths into a single optical fiber and output it to a light intensity amplitude modulator; the light intensity amplitude modulator modulates the multiplexed light and loads the one-dimensional tensor signal onto different wavelengths to achieve optical full connection weight loading;
(4) selecting the optical full connection channel for the optical switch, and outputting the weighted optical signals to a wavelength demultiplexer, which separates multiple wavelengths of light, detects the intensity of light of different wavelengths, and converts into electrical signals and outputs to the computer; by time accumulation, the intensity of different wavelengths of light is obtained;
(5) according to the intensity of different light wavelengths, classifying the sensing events into: background, knocking, walking, and fence; the wavelength of the programmable multi-wavelength laser array is 4 bands; the higher the light intensity, the higher the probability of the corresponding sensing event, and the band with the highest light intensity corresponds to the predicted result.

2. The distributed optical fiber sensing event recognition method based on optical computing of claim 1, wherein in the optical convolution computing part, expanding the two-dimensional image signal into a one-dimensional tensor specifically includes:
S1. traversing the input image, with the stride size as the step size, and extracting a local area at each position of the image;
S2. expanding each local area into a column vector and arranging them in columns of the output matrix;
S3. outputting matrix; the entire output matrix contains all possible local areas in the input image, and each column of the matrix corresponds to a local area in the input image.

3. The distributed optical fiber sensing event recognition method based on optical computing of claim 1, wherein in the optical convolution computing part, restoring into a feature graph specifically includes:
S1. traversing the input column vectors and restoring each column vector to a local area in the original image according to the corresponding position;
S2. filling each local area back to the corresponding position of the original image;
S3. outputting an image, which is the restored original image.

4. The distributed optical fiber sensing event recognition method based on optical computing of claim 1, wherein in the optical full connection computing part, it involves converting electronic signals into optical signals and using optical signals for data processing and classification, which includes the following steps:
S1. converting the weight of the full connection layer into an electrical signal: the weight of the full connection layer needs to be sent to the microprocessor, and the microprocessor generates a corresponding electrical signal based on the received weight data;
S2. electrical signals modulate laser array: the microprocessor uses electrical signals to modulate the programmable multi-wavelength laser array; each laser emits a light signal of a specific wavelength; at the same time, the microprocessor sends the flattened one-dimensional tensor data to the arbitrary waveform generator, which generates the corresponding time domain waveform to the light intensity amplitude modulator for further modulating the light signal;
S3. multiplexing and modulating optical signals: using wavelength division multiplexing technology to combine optical signals of different wavelengths and transmitting to a single optical fiber; the optical signals are further modulated when passing through the light intensity amplitude modulator to load the one-dimensional tensor signal onto light of different wavelengths, that is, loading the corresponding full connection layer weights on each wavelength;
S4. demultiplexing wavelength and detecting signals: the optical signals after weight loading are transmitted to the wavelength demultiplexer through the optical fiber, and the demultiplexer separates the multiplexed optical signals into different wavelengths; the light intensity of each wavelength is converted into an electrical signal through the optical detector and output to the computer; the computer performs temporal accumulation processing on the light intensity of different wavelengths to obtain the total light intensity information of each wavelength;
S5. classifying and predicting: according to the light intensity of different wavelengths, the computer classifies the sensing events, including background, knocking, walking, and fence;
according to the preset mode, the higher the light intensity band, the higher the probability of the corresponding event.

5. The distributed optical fiber sensing event recognition method based on optical computing of claim 1, wherein in the optical full connection computing part, combined with the Dropout operation, the events of distributed optical fiber sensing are: background, knocking, walking, and fence, corresponding to the outputs Y₁, Y₂, Y₃, and Y₄; assuming that the output is each neuron, the output can be expressed by the following formula:
$${Y}_{i} = WX + b$$
wherein X is the input of the current layer, W is the pre-trained weight matrix, and b is the bias vector; when performing optical full connection computing:
$${Y}_{i} = {W}^{′} X$$
$${W}^{′} = \frac{WX + b}{X}$$
when implementing optical full connection computing on the optical path, it is only necessary to load weights on the programmable multi-wavelength laser array, corresponding to the customized intensity output of each wavelength on the programmable multi-wavelength laser array, and finally output different light intensities for each wavelength.

6. The distributed optical fiber sensing event recognition method based on optical computing of claim 1, wherein in the optical full connection computing part, for discrete systems, the intensity and routing of multiple wavelengths are controlled through a programmable multi-wavelength laser array, and the update rate of the weight on the programmable multi-wavelength laser array is consistent with the modulator rate to ensure clock synchronization; for on-chip integrated systems, an light intensity amplitude modulator is used to load the full connection weights onto the time domain waveform of a one-dimensional tensor signal to complete the loading of the weights of each wavelength.

7. The distributed optical fiber sensing event recognition method based on optical computing of claim 1, wherein the input image size of the improved YOLOv8 micro detection framework is [3, 750, 750], and the output image size after positioning and cropping is [n, 3, 128, 128].

8. A distributed optical fiber sensing event recognition device based on optical computing, wherein the device can implement the method in claim 1; the device specifically comprises: a narrow linewidth laser, a first optical coupler, an acousto-optic modulator, an erbium-doped fiber amplifier, a circulator, a sensing fiber, a second optical coupler, a first photodetector, an acousto-optic modulation driver, a data acquisition card, a computer, a programmable multi-wavelength laser array, a wavelength multiplexer, an arbitrary waveform generator, an intensity amplitude modulator, an optical switch, a first semiconductor optical amplifier, a wavelength demultiplexer, a photodetector array, a second semiconductor optical amplifier, a second photodetector, a multi-channel parallel data acquisition card, and a microprocessor;
the narrow linewidth laser is used to emit narrow linewidth and high-correlation continuous laser;
the first optical coupler is used to split the continuous laser light input by the narrow linewidth laser into two paths, one path is a detection light signal, and the other path is a reference light signal;
the acousto-optic modulator is modulated by the acousto-optic modulation driver to modulate the continuous laser input by the first optical coupler into a pulse probe laser;
the erbium-doped fiber amplifier is used to amplify the pulse probe laser input by the acousto-optic modulator;
the loop is used to input the pulse probe laser amplified by the erbium-doped fiber amplifier into the sensing fiber, and receive the back Rayleigh scattered light reflected by the sensing fiber;
the second optical coupler is used to couple the reference optical signal input by the first optical coupler and the back Rayleigh scattered light input by the loop;
the first photodetector is used to detect the coupled light input by the second optical coupler and convert the coupled light into interference electrical signals;
the data acquisition card is used to collect the interference electrical signal of the first photodetector, and convert the interference electrical signals into digital signals, and output it to a computer; the data acquisition card is also used to output a clock carrier signal and a pulse trigger modulation signal to the acousto-optic modulation driver, so that the acousto-optic modulator outputs a high-level pulse modulation signal to the acousto-optic modulator;
the computer is used to control the working state of the data acquisition card and analyze and process the digital signals collected by the data acquisition card;
the microprocessor is controlled by the computer and is used to send clock signals and weights to the programmable multi-wavelength laser array;
the programmable multi-wavelength laser array is used to output lasers with different wavelength weights;
the wavelength multiplexer is used to multiplex a plurality of lasers of different wavelengths into a single optical fiber and output them to the light intensity amplitude modulator;
the arbitrary waveform generator is controlled by the microprocessor and is used to convert the time domain waveform signals generated by the microprocessor into a high-speed waveform;
the light intensity amplitude modulator is used to load the high-speed waveform generated by the arbitrary waveform generator onto each wavelength in a single optical fiber, complete the loading of the time domain signal, and output to the optical switch;
the optical switch switches the optical convolution computing and the optical full connection computing according to the clock signals sent by the microprocessor, and outputs to the first semiconductor optical amplifier or the single-mode optical fiber under different electrical signals;
the single-mode optical fiber is used to generate a time delay of one bit between the time domain waveforms of each wavelength, and output it to the second semiconductor amplifier;
the second semiconductor amplifier is used to amplify the optical signal that needs to be subjected to optical convolution computing;
the second photodetector is used to detect the time domain intensity of the optical signal amplified by the second semiconductor amplifier, and output the total power of all wavelengths of light in each time interval, and convert the total power of all wavelengths of light in each time interval into an electrical signal;
the first semiconductor optical amplifier is used to amplify the optical signal that needs to be subjected to optical full connection computing;
the wavelength demultiplexer is used to demultiplex the optical signal that needs to be subjected to optical full connection computing, separate a plurality of lights of different wavelengths, and convert the plurality of lights of different wavelengths into electrical signals;
the photodetector array is used to detect the intensity of the multiple lights of different wavelengths and convert the intensity of the multiple lights of different wavelengths into electrical signals;
in optical convolution computing, the multi-channel parallel data acquisition card is used to receive the electrical signals of the second photodetector;
in optical full connection computing, the multi-channel parallel data acquisition card is used to receive the electrical signals of the photodetector array and output to the computer;
the computer is also used to receive the electrical signals collected by the multi-channel parallel data acquisition card, convert the electrical signals into two-dimensional time-frequency signals, convert the two-dimensional time-frequency signals into one-dimensional tensors, and restore the one-dimensional signals after optical convolution computing into two-dimensional time-frequency signals, output the judgment results of distributed optical fiber sensing events: background, knocking, walking, and fence, and output the clock signals, weights, and one-dimensional tensors to the microprocessor;
the microprocessor is also used to convert the one-dimensional tensor into a time domain waveform signal and output to the arbitrary waveform generator.

9. The distributed optical fiber sensing event recognition device based on optical computing of claim 8, wherein the rate of the arbitrary waveform generator is 12.5 Gbps, the vertical resolution is 10 bits, the bandwidth is 5.3 GHZ, and the corresponding time to send one bit is 80 ps.

10. The distributed optical fiber sensing event recognition device based on optical computing of claim 8, wherein the dispersion coefficient of the single-mode optical fiber is 20 ps/(nm·km), the distance is 2 km, and the wavelength change is 2 nm.
